(19) United States
(12) Patent Application Publication
(10) Pub. No.: US 2009/0250924 A1
(43) Pub. Date: Oct. 8, 2009

(54) Anti-kink hose support sleeve for garden hoses

(76) Inventors: Thomas A. Tisbo, Batavia, IL (US); Dennis A. Matousek, West Chicago, IL (US)

Correspondence Address: MCHALE & SLAVIN, P.A., 2855 PGA BLVD, PALM BEACH GARDENS, FL, 33410, US

(21) Appl. No.: 12/062,878

(22) Filed: Apr. 4, 2008

(51) Int. Cl. F16L 35/00

(52) U.S. Cl. 285/115

(57) ABSTRACT

The present invention is directed toward an anti-kink support sleeve for flexible hoses such as garden hoses. The construction of the device permits flexation of the hose while preventing the hose from kinking or collapsing in proximity of the support sleeve and most particularly near the hose bib. The anti-kink support sleeve includes a plurality of interconnected section members. Each interconnected section member includes a ball end and a socket end. The socket end being constructed to cooperate with the ball end of an adjacently positioned section to construct a universally swiveling connection having an inner diameter of sufficient size to pass the hose member therethrough. A plurality of sections are interconnected to assemble the anti-kink hose sleeve having a sufficient length to support the desired section(s) of hose.

### FIELD OF INVENTION

The present invention generally relates to hoses, such as those used to supply water for gardening, and more particularly, to a reinforcement sleeve which provides anti-kinking support to the hose.

### BACKGROUND INFORMATION

Various types of hoses are commonly used for conveying fluids such as water to sprinklers, sprayers, recreational devices and the like. Common types of hose are constructed from rubber and/or flexible plastic tubing and are provided with threaded male and female couplings at the distal ends which facilitate attachment to, and detachment from, fluid sources and various fluid-receiving devices. The female couplings of such hoses are generally designed to cooperate with standard male-threaded hose bibs, which are typically provided on the exteriors of buildings, well heads and water distribution systems. In a typical exterior hose bib installation, the male threaded coupling is positioned within a few inches of an exterior wall and slants downwardly and outwardly therefrom. The hose bib is generally provided with a valve to control the flow of water through the bib and thus the hose.

One disadvantage associated with the aforementioned hose coupling system generally occurs when the flexible hose is pulled in a direction not aligned with the hose bib coupling. This often results in the hose becoming kinked or collapsed adjacent to its end whereby water flow is reduced or blocked from flowing through the hose. As a result it is known in the art to place a piece resilient tubular member or spring around the hose in proximity to the connector(s) to increase the force required to kink the hose.

For example, U.S. Pat. Nos. 5,857,711, D501,539, 6,604,758, 6,193,282, and 4,487,444 disclose various springs and or tubular rubber members which are located internal or external to the hose to reduce the ability of the hose to kink or collapse. A drawback to these devices relates to coiling the hoses onto a storage device such as a hose reel or hose hanger. The sleeves and/or springs resist conformation to the diameter of the spool requiring extra space as well as causing cross-threading and hose entanglement.

Therefore, there exists a need for an anti-kink device for hoses that reduces or eliminates kinking and/or collapse of the hose in proximity to a hose bib and yet allows the hose to be easily coiled about a storage device such as a hose reel or hanger.

Thus, the present invention provides a system and device which overcomes the disadvantages of prior art anti-kink devices. The anti-kink system of the present invention not only provides for relative ease in manufacturing and installation of the system, it also permits customization of the anti-kink device as well as connectivity to hose storage devices.

### SUMMARY OF THE INVENTION

Briefly, the present invention is directed toward an anti-kink support sleeve for flexible hoses such as garden hoses. The construction of the device permits flexation of the hose while preventing the hose from kinking or collapsing in proximity of the support sleeve and most particularly near the hose bib. The anti-kink support sleeve includes a plurality of interconnected section members. Each interconnected section member includes a ball end and a socket end. The socket end being constructed to cooperate with the ball end of an adjacently positioned section to construct a universally swiveling connection having an inner diameter of sufficient size to pass the hose member therethrough. A plurality of sections are interconnected to assemble the anti-kink hose sleeve having a sufficient length to support the desired section(s) of hose. The assembled anti-kink hose sleeve is secured to the hose or fittings via mechanical cooperation with the fittings secured to the ends of the hose or alternatively with suitable adhesive or fastener. In a most preferred embodiment the anti-kink hose sleeve is secured in proximity to the ends of the hose to prevent hose kinking and/or collapse in the area where the hose interconnects with the hose bib.

Accordingly, it is an objective of the present invention to provide a flexible hose construction wherein the flexibility characteristics of an inner hose member are not substantially diminished by having an outer sleeve of rigid tubular members connected for movement with respect to each other to support the outer diameter of the hose member to prevent kinking of the inner hose member.

It is a further objective of the present invention to provide a plurality of interconnected tubular members that are placed about a flexible hose member to prevent kinking of the hose member in proximity to a hose bib.

It is yet a further objective of the present invention to provide an anti-kink hose sleeve comprising a plurality of tubular members each having a ball end and a socket end wherein the ball end of one rigid member is interconnected with the socket end of an adjacent rigid member for universal movement therebetween.

It is still yet another objective of the present invention to provide hose construction having an outer sleeve of rigid tubular members wherein the flexibility characteristics of the combined hose member and outer sleeve permit unencumbered winding about a hose storage device.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a side view partially sectioned illustrating one embodiment of the instant invention in cooperation with a hose bib;

FIG. 2 is a partial perspective view of one embodiment of the instant invention;

FIG. 3A is a partial side view of one embodiment of the instant invention;

FIG. 3B is a partial section side view of the embodiment illustrated in FIG. 3A;

FIG. 4 is a perspective view of one embodiment of the instant invention;

FIG. 5 is a perspective view illustrating the instant invention in cooperation with a hose reel.

FIG. 6 is a section view taken along lines 6-6 of FIG. 2.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

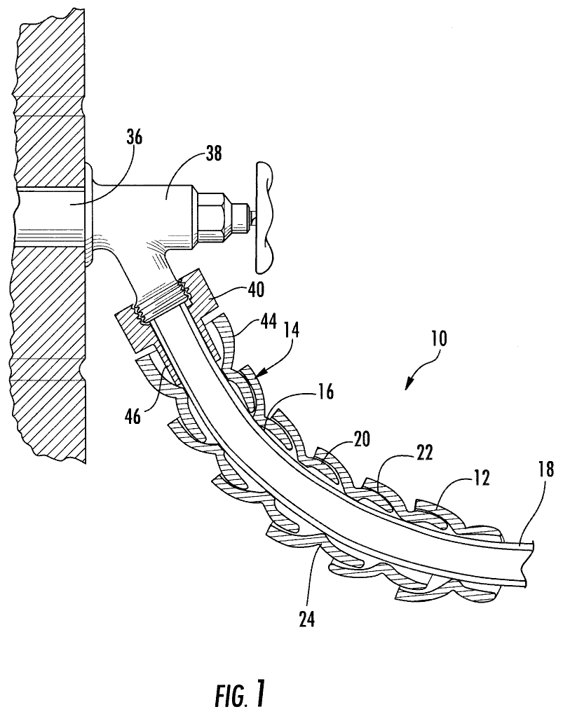

Referring generally to FIGS. 1-4, an anti-kink hose support sleeve system 10 for garden hoses and the like is illustrated. The system includes a plurality of tubular sleeve members 12 forming an outer sleeve assembly 14 and defining an annular space 16 sized for accepting a hose member 18 therethrough. The sleeve members 12 include a first end having a generally spherical portion 20 and a second end having a socket 22 both arranged substantially along the longitudinal centerline of each sleeve member 12. The socket 22 is generally constructed and arranged for overlapping interconnection with the spherical portion 20 of the first end of an adjacently positioned sleeve member for universal and rotational movement therebetween. In a most preferred embodiment, the first and second ends of each sleeve member are spaced relatively closely adjacent to each other, connected by a short, cylindrical throat portion 24. The close spacing allows the hose sleeve assembly to be bent into relatively extreme shapes while preventing kinking and/or collapse of the hose 18. The socket 22 in the second end receives the spherical end 20 of an adjacent sleeve member 12 by snapping together so that each sleeve member can be pivoted and rotated with respect to one another. The fit of the spherical end 20 in the socket end 22 may be tight enough to create a friction fit, or a resistance between snapped-together sleeve members, that allows the members to maintain their position relative to one another without undesired relative movement unless an adequate force is applied to change the configuration. Alternatively, the fit between the spherical end 20 in the socket end 22 of the sleeve members 12 may include a clearance fit which conforms to the shape of the hose while still preventing kinking and/or collapse of the hose member 18. In a most preferred embodiment, an anti-kink hose sleeve having a length of about eight inches is provided at one or both ends of a length of hose. However, it should be noted that because the sleeve members can be snapped together an anti-kink hose sleeve of virtually any length can be constructed.

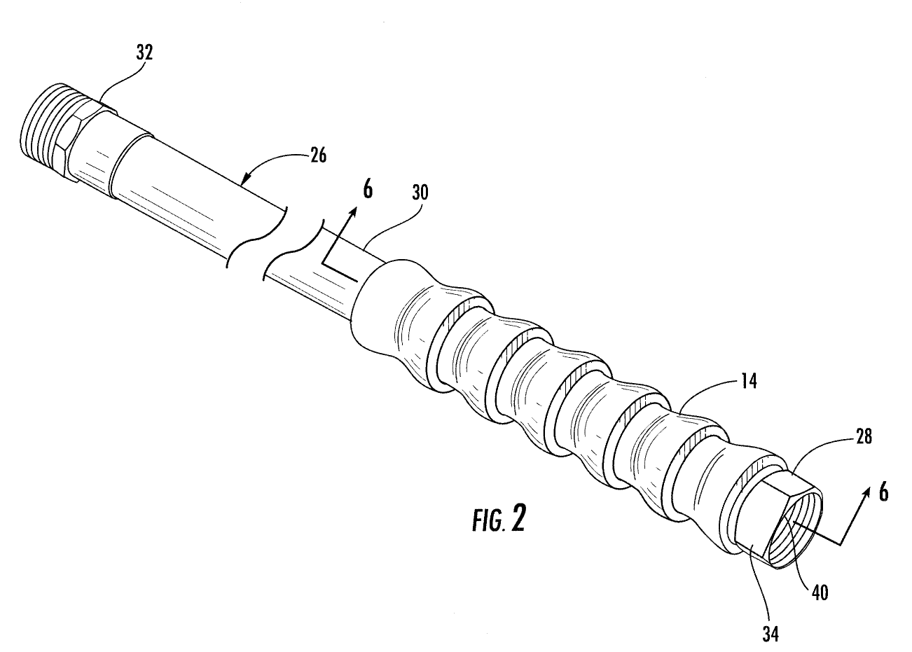

Referring to FIG. 2, one embodiment of the instant invention is illustrated wherein an anti-kink hose sleeve is provided at one end of a hose member 26. The hose member 26 is constructed of a resilient material for transfer of fluids, e.g. air or liquid. In a most preferred embodiment the hose member is constructed of a polymeric material such as vinyl and may include reinforcing materials such as nylon. Such constructions are well known for use as gardening or recreational vehicle supply hoses. The hose member generally includes a first end 28, a middle portion 30 and a second end 32. At least one of the first or second ends 28,32 includes a fitting 34 secured thereto for attachment to a fluid supply line 36 (FIG. 1).

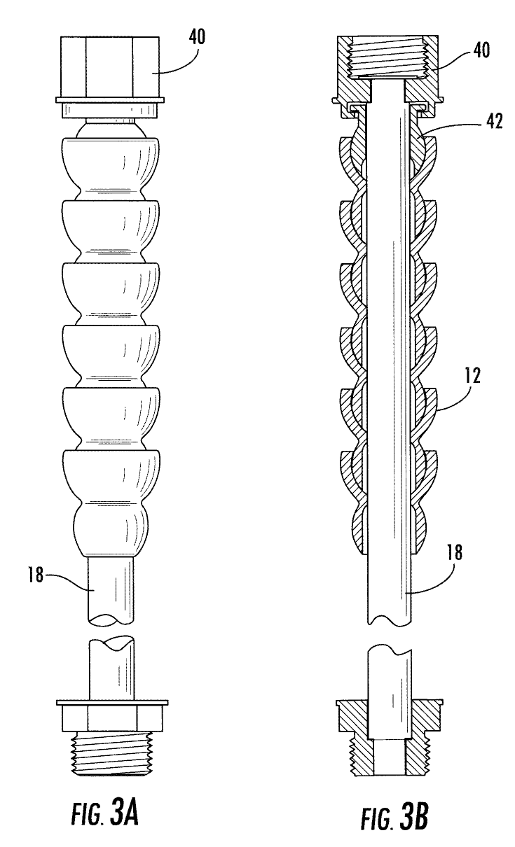

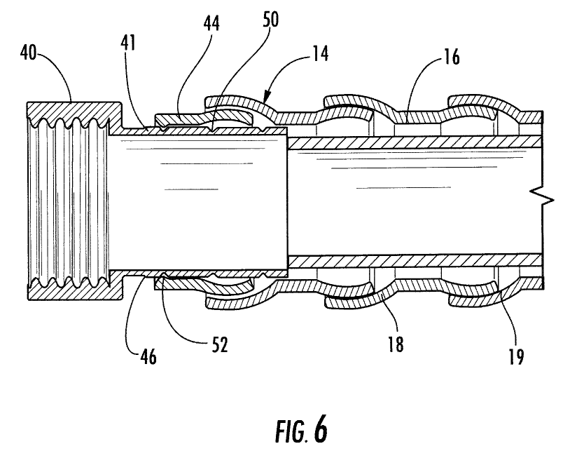

Referring to FIGS. 1-4 and 6, the anti-kink hose sleeve of the instant invention may be secured to the hose member in a number of ways which may include, but should not be limited to, frictional engagement, adhesive, inter-fitting components, clamps and the like. The anti-kink hose is preferably secured to the hose member in close proximity to one of the distal ends of the hose to prevent kinking and/or collapse of the hose member in proximity to the hose bib 38. However, it should be noted that the anti-kink hose sleeve may be utilized to support any area along the length of the hose member subject to kinks and/or collapse. FIG. 1 illustrates a frictional engagement between the inner lumen 16 of the sleeve assembly 14 and the outer diameter 19 of the hose member 18. The frictional engagement may be limited to one area or may extend along the entire length of the sleeve assembly. In one embodiment, a portion of the inner lumen 16 of the sleeve assembly 14 engages a ferule portion 46 of the fitting 40. As illustrated in FIGS. 3A and 3b the fitting 40 may include a spherical engagement portion 42 which is constructed and arranged to allow the fitting to rotate independent of the hose member and the spherical engagement portion. Alternatively, the end sleeve member 44 may be constructed and arranged to frictionally cooperate with the ferrule portion 46 of the fitting 40. In another embodiment (FIG. 2), the sleeve assembly is constructed and arranged for rotation of the fitting 40, whereby rotation of the sleeve assembly 14 provides rotation to the fitting. In a most preferred embodiment (FIG. 6), the ferrule portion 46 of the fitting 40 is provided with a plurality of circumferential grooves 50. The grooves are constructed and arranged to cooperate with at least one inwardly extending ribs 52 positioned in the inner lumen of the end sleeve member 44. The inner fitting arrangement of the rib and groove can provide releasable or permanent placement of the sleeve assembly 14 and may provide rotation or fixed engagement.

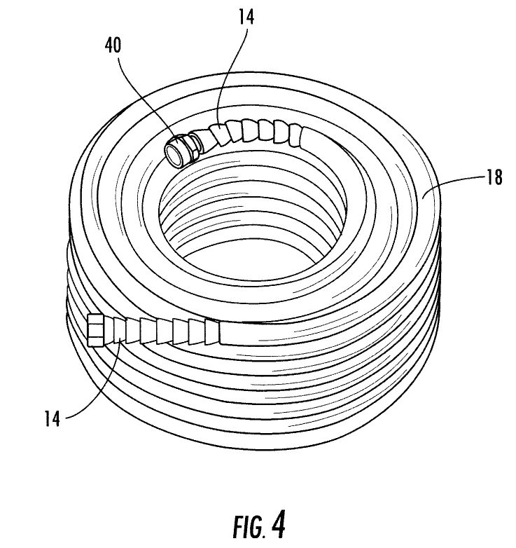

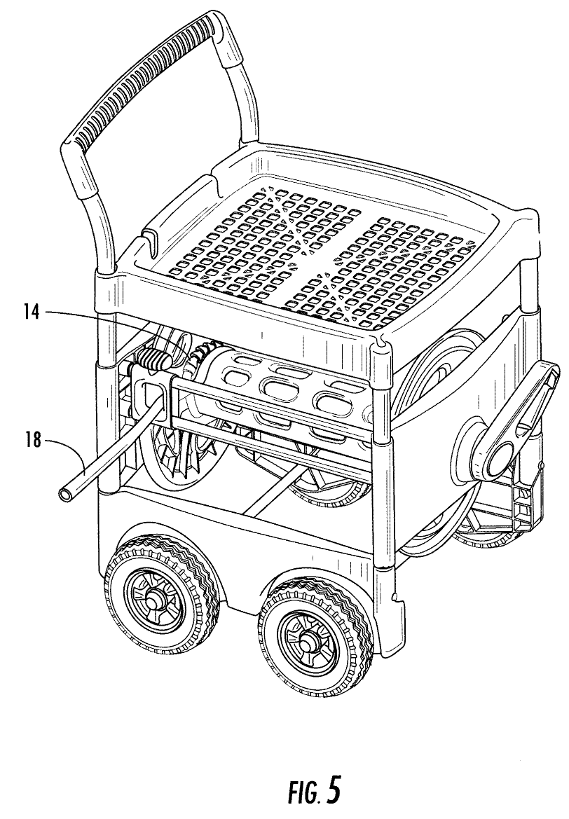

Referring to FIG. 4, a hose member 18 is illustrated having an anti-kink hose sleeve assembly 14 secured to both distal ends of the hose member. In this illustration it is readily apparent how the non-elastomeric nature of the instant invention advances the art of anti-kink devices for hoses. The instant invention provides unencumbered winding about hose storage devices such as the hose reel shown in FIG. 5 as well as hose hangers which are well known in the art.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objects and obtain the ends and advantages mentioned, as well as those inherent therein. Any compounds, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A flexible sleeve assembly for preventing kinks in a hose member comprising:
a plurality of tubular sleeve members forming an outer sleeve assembly and defining an annular space sized for accepting a hose member therethrough, each said sleeve member including a first end having a generally spherical portion and a second end having a socket both arranged substantially along the longitudinal centerline of said sleeve member, said second end being constructed and arranged for overlapping interconnection with said first end of an adjacently positioned sleeve member for universal movement therebetween, an end sleeve member secured to a distal end of said sleeve assembly for securing said sleeve assembly in proximity an end fitting of said hose, whereby the universal flexibility of the combined hose member and outer sleeve assembly prevent kinking of said hose member while providing unencumbered winding about a hose storage device.

2. The sleeve assembly of claim 1 wherein said end sleeve member is secured to said end fitting of said hose member via friction between said end sleeve member and said end fitting.

3. The sleeve assembly of claim 1 wherein said end sleeve member is secured to said end fitting of said hose member via adhesive between said end sleeve member and said end fitting.

4. The sleeve assembly of claim 1 wherein said sleeve assembly is secured to said hose member via friction between an inner surface of said annular space and an outer surface of said hose member.

5. The sleeve assembly of claim 1 wherein at least a portion of said socket in said second end of said sleeve member is spherical in shape.

6. The sleeve assembly of claim 1 wherein said end sleeve member is secured to said end fitting of said hose member via an inwardly extending rib member constructed and arranged to cooperate with at least one groove on said end fitting of said hose.

7. The sleeve assembly of claim 6 wherein said at least one groove is positioned on a ferule portion of end fitting of said hose.

8. A kink resistant flexible hose assembly comprising:
a hose member constructed of a resilient material for transfer of fluids, said hose member including a first end, a middle portion and a second end, at least one of said first or second ends including a fitting secured thereto for attachment to a pressurized fluid supply line;
a plurality of tubular sleeve members forming an outer sleeve assembly and defining an annular space sized for accepting said hose member therethrough, each said sleeve member including a first end having a generally spherical portion and a second end having a socket both arranged substantially along the longitudinal centerline of said sleeve member, said second end being constructed and arranged for overlapping interconnection with said first end of an adjacently positioned sleeve member for universal movement therebetween, an end sleeve member secured to a distal end of said sleeve assembly for securing said sleeve assembly in proximity said fitting of said hose, whereby the universal flexibility of the combined hose member and outer sleeve assembly prevent kinking of said hose member while providing unencumbered winding about a hose storage device.

9. The sleeve assembly of claim 8 wherein said end sleeve member is secured to said end fitting of said hose member via friction between said end sleeve member and said end fitting.

10. The sleeve assembly of claim 8 wherein said end sleeve member is secured to said end fitting of said hose member via adhesive between said end sleeve member and said end fitting.

11. The sleeve assembly of claim 8 wherein said sleeve assembly is secured to said hose member via friction between an inner surface of said annular space and an outer surface of said hose member.

12. The sleeve assembly of claim 8 wherein at least a portion of said socket in said second end of said sleeve member is spherical in shape.

13. The sleeve assembly of claim 8 wherein said hose sleeve is constructed and arranged for rotation of said fitting, whereby rotation of said sleeve assembly provides rotation to said fitting.

14. The sleeve assembly of claim 8 wherein said first end spherical portion and said second end socket include an interference fit therebetween.

15. The sleeve assembly of claim 8 wherein said first end spherical portion and said second end socket include a clearance fit therebetween.

16. The sleeve assembly of claim 8 wherein said end sleeve member is secured to said end fitting of said hose member via an inwardly extending rib member constructed and arranged to cooperate with at least one groove on said end fitting of said hose.

17. The sleeve assembly of claim 8 wherein said at least one groove is positioned on a ferule portion of end fitting of said hose.
